(19) United States
(12) Patent Application Publication
(10) Pub. No.: US 2026/0255100 A1
(43) Pub. Date: Aug. 27, 2026

(54) OPEN-TYPE SOUND GUIDE EARPHONE

(71) Applicant: Yan-Ru PENG, New Taipei (TW)

(72) Inventor: Yan-Ru PENG, New Taipei (TW)

(21) Appl. No.: 19/419,633

(22) Filed: Dec. 15, 2025

(30) Foreign Application Priority Data
Feb. 21, 2025 (TW) 114201813

(51) Int. Cl. H04R 1/32; H04R 1/10

(52) U.S. Cl. CPC H04R 1/323; H04R 1/1016; H04R 1/105

(57) ABSTRACT

An open-type sound guide earphone includes a housing, a sound transmission tube disposed on one side of the housing and extending outward, and a sound field adjustment ring. A front end of the sound transmission tube is configurated to be plugged in the concha cavity of a user's ear and has an insertion section. The sound field adjustment ring is fitted onto the insertion section. By selecting a sound field adjustment ring of appropriate length or diameter, the sound field can be adjusted appropriately. The sound transmission tube is adjustable in position so that the sound can be directed to the correct location, thereby enhancing the sound quality for the user.

### FIELD OF THE INVENTION

The present invention relates to an earphone, and more particularly to an open-type sound guide earphone.

### BACKGROUND OF THE INVENTION

Users often use earphones to listen to the sound reproduced by a playback device, such as music played on a mobile phone. To achieve superior sound quality, existing earphones are positioned directly in the user's ear canal, blocking the entire passage to utilize it as a resonance chamber. This enhances the richness of mid and low frequencies.

However, the aforementioned method requires completely sealing the ear canal. This not only causes a sensation of blockage during use but also leads to excessive resonance that compromises sound clarity. Particularly after prolonged wear, the ear canal cannot effectively release sound pressure, resulting in auditory fatigue and hearing deterioration. Furthermore, completely sealing the ear canal prevents users from hearing external sounds, raising significant concerns about safety.

In view of this, the inventor developed an open-back earphone and obtained U.S. Pat. No. 8,111,854. When in use, the earphone is placed on a user's ear and positioned on the outer side of the auricle. The earphone has a housing with an opening on one side thereof. A speaker is fixed in the opening. The diaphragm of the speaker faces outward from the opening. A sound transmission tube is provided on the other side of the housing. One end of the sound transmission tube is plugged in the concha cavity, thereby directing sound into the concha cavity and reflecting the sound into the ear canal using the auricle's sound-receiving mechanism. This design not only directs the sound emitted by the speaker into the ear canal without sealing the ear canal, thus effectively overcoming the shortcomings of existing earphones. By employing an acoustic principle of 80% reflection and 20% direct sound, it creates a three-dimensional sound field within the auricle, thereby effectively reproducing authentic sound.

The open-back earphone developed by the inventor effectively improves the shortcomings of existing in-ear headphones. However, because the end of the sound transmission tube is of a fixed size, it is impossible to make appropriate adjustments to the sound field. Besides, the sound transmission tube is fixedly connected to the housing, so the position of the sound transmission tube cannot be adjusted. Because the size of each person's ear varies, if the sound transmission tube is not positioned correctly, the optimal resonance effect will not be achieved. These issues have all imposed limitations on the sound quality for users and still require improvement.

Accordingly, the inventor of the present invention has devoted himself based on his many years of practical experiences to solve these problems.

### SUMMARY OF THE INVENTION

The primary object of the present invention is to provide an open-type sound guide earphone, which allows for appropriate adjustment of the sound field by selecting a sound field adjustment ring of appropriate length or diameter, thereby enhancing the sound quality for the user.

Another object of the present invention is to provide an open-type sound guide earphone, which allows a sound transmission tube to be adjusted in position so that the sound can be directed to the correct location, thereby enhancing the sound quality for the user.

In order to achieve the open-type sound guide earphone provided by the present invention comprises an ear hook, a housing, a sound transmission tube, and a sound field adjustment ring. The housing is connected to the ear hook. The sound transmission tube is disposed on one side of the housing and extends obliquely downward. A front end of the sound transmission tube is configurated to be plugged in the concha cavity of a user's ear. The front end of the sound transmission tube has an insertion section. The sound field adjustment ring has a ring body. The ring body is fitted onto the insertion section of the sound transmission tube. The sound field adjustment ring has an outer annular cover on an outer periphery of the ring body. The sound field adjustment ring has a predetermined length and a predetermined diameter.

Preferably, a positioning annular groove is recessed on an outer peripheral wall of the insertion section, and an inner peripheral wall of the ring body has a positioning flange corresponding to the positioning annular groove.

Preferably, the insertion section is perpendicular to the side of the housing.

Preferably, one end of the outer annular cover is fixed to the ring body, another end of the outer annular cover is a free end, and a gap is formed between the outer annular cover and the ring body.

Preferably, the sound field adjustment ring is integrally formed from a soft and flexible plastic material.

Preferably, the sound transmission tube is pivotally connected to the housing.

Preferably, the housing has a circular pivot groove therein, and a rear end of the sound transmission tube has a circular pivot seat corresponding to the pivot groove. The pivot seat is pivotally mounted in the pivot groove, enabling the sound transmission tube to be adjusted in position on the housing by means of a pivoting action between the pivot groove and the pivot seat.

Preferably, the housing further includes an outer lid. The outer lid has an arc-shaped elongated guide hole corresponding in position to the sound transmission tube. The sound transmission tube passes through the elongated guide hole and extends outward, allowing the sound transmission tube to undergo only a limited range of positional adjustment within the elongated guide hole.

### BRIEF DESCRIPTION OF THE DRAWINGS

FIG. 1 is an exploded view according to a first embodiment of the present invention;

FIG. 2 is a perspective view according to the first embodiment of the present invention;

FIG. 3 is a partial cross-sectional view according to the first embodiment of the present invention;

FIG. 4 is a schematic view according to the first embodiment of the present invention when in use;

FIG. 5 is a partial cross-sectional view according to a second embodiment of the present invention;

FIG. 6 is an operational schematic view according to a third embodiment of the present invention; and

FIG. 7 is an operational schematic view according to a fourth embodiment of the present invention.

### DETAILED DESCRIPTION OF THE PREFERRED EMBODIMENTS

Embodiments of the present invention will now be described, by way of example only, with reference to the accompanying drawings.

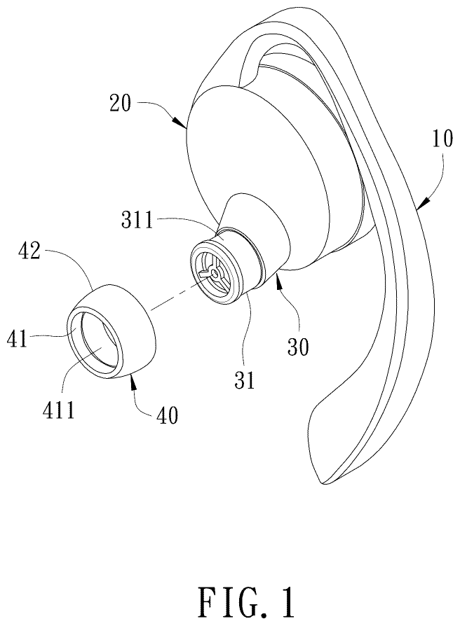

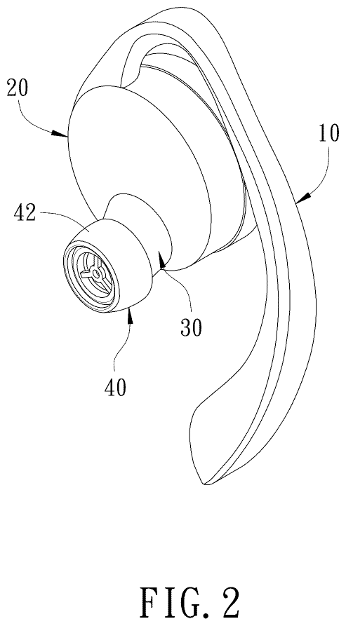

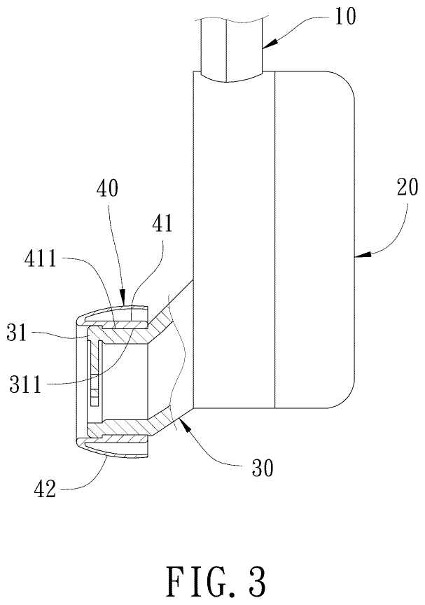

FIG. 1 is an exploded view according to a first embodiment of the present invention. FIG. 2 is a perspective view according to the first embodiment of the present invention. FIG. 3 is a partial cross-sectional view according to the first embodiment of the present invention. The present invention discloses an open-type sound guide earphone, comprising an ear hook 10, a housing 20, a sound transmission tube 30, and a sound field adjustment ring 40.

The housing 20 is disc-shaped and connected to the ear hook 10. A speaker is mounted inside the housing 20. The sound transmission tube 30 has a cylindrical shape and is disposed on one side of the housing 20 and extends obliquely downward. The front end of the sound transmission tube 30 is configurated to be plugged in the concha cavity of a user's ear. Since the above structure is a well-known technique, it will not be elaborated upon here. The main improvement of the present invention is described below.

The front end of the sound transmission tube 30 has an insertion section 31. The insertion section 31 is perpendicular to the side of the housing 20 and is also cylindrical. A positioning annular groove 311 is recessed on the outer peripheral wall of the insertion section 31.

The sound field adjustment ring 40 is integrally formed from a soft and flexible plastic material, which not only reduces the risk of ear injury but also allows for easy installation, removal, and replacement. The sound field adjustment ring 40 has a ring body 41. The inner peripheral wall of the ring body 41 has a positioning flange 411 corresponding to the positioning annular groove 311. The positioning flange 411 is positioned in the positioning annular groove 311, thereby securing the ring body 41 in place. The sound field adjustment ring 40 has an outer annular cover 42 that is integrally formed on the outer periphery of the ring body 41. One end of the outer annular cover 42 is fixed to one end of the ring body 41, and the other end of the outer annular cover 42 is a free end. A gap is formed between the outer annular cover 42 and the ring body 41. The sound field adjustment ring 40 is formed with a predetermined length through the ring body 41 and a predetermined diameter through the outer annular cover 42. When the sound field adjustment ring 40 has a smaller diameter, it occupies less space in the concha cavity, being less likely to block external environmental sounds. This allows it to blend better with ambient sounds, making it suitable for activities such as cycling, driving, and outdoor sports, enabling users to remain aware of traffic conditions or on-site environmental changes at all times. Conversely, when the sound field adjustment ring 40 has a larger diameter, it occupies a relatively greater space in the concha cavity, thereby blocking external sounds from entering the user's ear. Since it effectively blocks out ambient noise, it is suitable for noisy environments such as subways and buses, minimizing interference from external sounds to the sound transmitted through the earphone. When the sound field adjustment ring 40 has a shorter length, it tends to have less of a volume-concentrating effect. Conversely, when the sound field adjustment ring 40 has a longer length, it can concentrate the emitted volume. For the low frequencies that tend to dissipate more easily in the open-type sound guide earphones, this feature provides an enhancing effect, thereby achieving a more saturated low-frequency sound. The high saturation of the low frequencies enriches the musical timbre, making it fuller and more vibrant, immersing the listener in an experience that feels like being right there. When a user wants to select a sound field adjustment ring 40 with a different diameter or length, the original sound field adjustment ring 40 is removed and replaced with one of a different diameter or length.

To further understand the structural features, technical means employed, and intended effects of the present invention, its usage and effects will be described below. This should offer a deeper and more concrete understanding of the present invention, as detailed below.

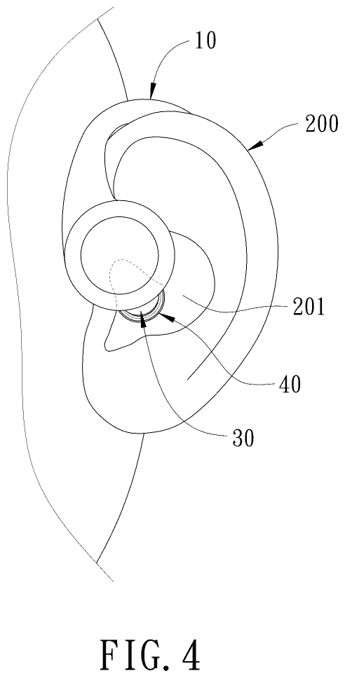

FIG. 4 is a schematic view according to the first embodiment of the present invention when in use. When in use, the earphone provided by the present invention is worn on the user's ear 200 through the ear hook 10. The sound transmission tube 30 faces the ear 200. The sound field adjustment ring 40 located at the front end of the sound transmission tube 30 is plugged in the concha cavity 201 of the ear 200. Thus, sound can be directed to the concha cavity 201 via the sound transmission tube 30 and then reflected into the ear canal by the auricle's sound-receiving mechanism. The sound field adjustment ring 40 effectively blocks excessive ambient noise, allowing the user to listen to the sound emitted by the speaker in the most natural way. This reduces the impact of sound pressure on the ear canal greatly, effectively avoiding hearing fatigue and hearing damage.

It is worth mentioning that the sound field adjustment ring 40 is integrally formed from a soft and flexible plastic material, and there is a gap between the outer annular cover 42 and the ring body 41, so that the outer annular cover 42 has a space to be squeezed and deformed, thereby protecting the ear from injury caused by contact with the sound transmission tube 30.

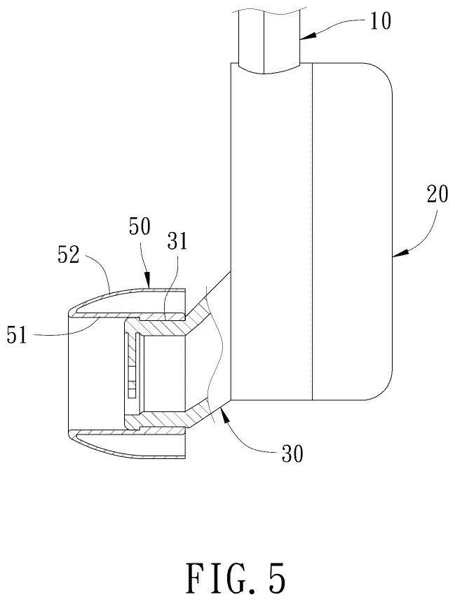

FIG. 5 is a partial cross-sectional view according to a second embodiment of the present invention. In the second embodiment, a sound field adjustment ring 50 is fitted onto the insertion section 31 of the sound transmission tube 30. The sound field adjustment ring 50 has a relatively long ring body 51 and a large-diameter outer annular cover 52. The sound field adjustment ring 50 features a longer length and larger diameter, which not only blocks more external ambient noise but also transmits richer, more saturated low-frequency sound.

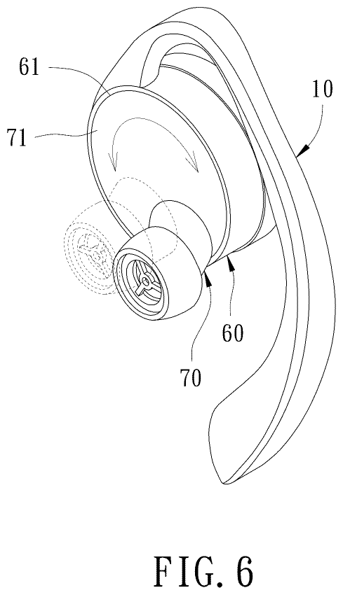

FIG. 6 is an operational schematic view according to a third embodiment of the present invention. The housing 60 has a circular pivot groove 61 therein. The rear end of the sound transmission tube 70 has a circular pivot seat 71 corresponding to the pivot groove 61. The pivot seat 71 is pivotally mounted in the pivot groove 61, enabling the sound transmission tube 70 to be adjusted in position on the housing 60 by means of the pivoting action between the pivot groove 61 and the pivot seat 71.

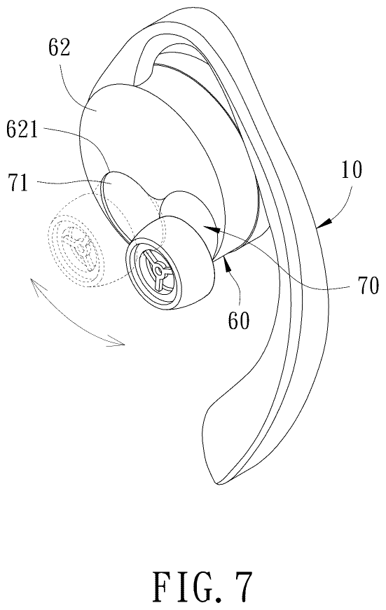

FIG. 7 is an operational schematic view according to a fourth embodiment of the present invention. In addition to the feature that the sound transmission tube 70 can be adjusted in position on the housing 60 by means of the pivoting action between the pivot groove 61 and the pivot seat 71, the housing 60 further includes an outer lid 62. The outer lid 62 has an arc-shaped elongated guide hole 621 corresponding in position to the sound transmission tube 70. The sound transmission tube 70 passes through the elongated guide hole 621 and extends outward, allowing the sound transmission tube 70 to undergo only a limited range of positional adjustment within the elongated guide hole 621. This range is designed to accommodate the varying sizes of individual ears, ensuring that the sound transmission tube 70 directs sound to the correct position (the resonance peak of the concha cavity). This principle is analogous to adjusting the height and placement of speakers in a living room.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An open-type sound guide earphone, comprising:
an ear hook;
a housing, connected to the ear hook;
a sound transmission tube, disposed on one side of the housing and extending obliquely downward, a front end of the sound transmission tube being configurated to be plugged in the concha cavity of a user's ear, the front end of the sound transmission tube having an insertion section,
a sound field adjustment ring, having a ring body, the ring body being fitted onto the insertion section of the sound transmission tube, the sound field adjustment ring having an outer annular cover on an outer periphery of the ring body, the sound field adjustment ring having a predetermined length and a predetermined diameter.

2. The open-type sound guide earphone as claimed in claim 1, wherein a positioning annular groove is recessed on an outer peripheral wall of the insertion section, and an inner peripheral wall of the ring body has a positioning flange corresponding to the positioning annular groove.

3. The open-type sound guide earphone as claimed in claim 1, wherein the insertion section is perpendicular to the side of the housing.

4. The open-type sound guide earphone as claimed in claim 1, wherein one end of the outer annular cover is fixed to the ring body, another end of the outer annular cover is a free end, and a gap is formed between the outer annular cover and the ring body.

5. The open-type sound guide earphone as claimed in claim 1, wherein the sound field adjustment ring is integrally formed from a soft and flexible plastic material.

6. The open-type sound guide earphone as claimed in claim 1, wherein the sound transmission tube is pivotally connected to the housing.

7. The open-type sound guide earphone as claimed in claim 6, wherein the housing has a circular pivot groove therein, a rear end of the sound transmission tube has a circular pivot seat corresponding to the pivot groove, and the pivot seat is pivotally mounted in the pivot groove, enabling the sound transmission tube to be adjusted in position on the housing by means of a pivoting action between the pivot groove and the pivot seat.

8. The open-type sound guide earphone as claimed in claim 7, wherein the housing further includes an outer lid, the outer lid has an arc-shaped elongated guide hole corresponding in position to the sound transmission tube, and the sound transmission tube passes through the elongated guide hole and extends outward, allowing the sound transmission tube to undergo only a limited range of positional adjustment within the elongated guide hole.
